(19) United States
(12) Patent Application Publication
(10) Pub. No.: US 2015/0115726 A1
(43) Pub. Date: Apr. 30, 2015

(54) ELECTRONIC DEVICE

(71) Applicant: SAMSUNG ELECTRO-MECHANICS CO., LTD., Suwon-Si (KR)

(72) Inventors: Chang Soo KANG, Suwon-Si (KR); Jae Suk SUNG, Suwon-Si (KR); Soon Tack OH, Suwon-Si (KR); Sung Uk LEE, Suwon-Si (KR); Hyun Keun LIM, Suwon-Si (KR); Si Hyung KIM, Suwon-Si (KR); Chul Gyun Gyun PARK, Suwon-Si (KR); Ki Won CHANG, Suwon-Si (KR)

(73) Assignee: SAMSUNG ELECTRO-MECHANICS CO., LTD., Suwon-Si (KR)

(21) Appl. No.: 14/262,364

(22) Filed: Apr. 25, 2014

(30) Foreign Application Priority Data
Oct. 31, 2013 (KR) 10-2013-0131599

(51) Int. Cl. H02J 5/00; H02J 7/04; H01F 38/14; H02J 7/02

(52) U.S. Cl. CPC H02J 5/005; H02J 7/025; H02J 7/04; H01F 38/14
USPC 307/104

(57) ABSTRACT

There is provided an electronic device including: a power reception unit having a plurality of power receiving coils and receiving a wireless power signal from a wireless power transmission device; a switching unit controlling an ON/OFF switching operation of the plurality of power receiving coils; and a control unit obtaining reception sensitivity of the power reception unit and controlling the switching unit based on the obtained reception sensitivity.

### CROSS-REFERENCE TO RELATED APPLICATION

This application claims the benefit of Korean Patent Application No. 10-2013-0131599 filed on Oct. 31, 2013, with the Korean Intellectual Property Office, the disclosure of which is incorporated herein by reference.

### BACKGROUND

The present disclosure relates to an electronic device having a wireless power signal reception function.

Recently, a method of wirelessly supplying electrical energy to electronic devices in a non-contact manner, instead of a conventional method of supplying electrical energy in a wired manner, has been introduced. Upon receiving energy wirelessly, electronic devices may be directly driven by the received wireless electric power, a battery disposed therein may be charged with the received wireless electric power and driven thereby.

### RELATED ART DOCUMENT

(Patent Document 1) Korean Patent Laid-Open Publication No. 2013-0034768
(Patent Document 2) Korean Patent Laid-Open Publication No. 2012-0051320

### SUMMARY

An aspect of the present disclosure may provide an electronic device having enhanced wireless charging efficiency.

An aspect of the present disclosure may also provide an electronic device having an enhanced degree of freedom in terms of schemes of being charged with electrical power.

According to an aspect of the present disclosure, an electronic device may include: a power reception unit having a plurality of power receiving coils and receiving a wireless power signal from a wireless power transmission device; a switching unit controlling an ON/OFF switching operation of the plurality of power receiving coils; and a control unit obtaining reception sensitivity of the power reception unit and controlling the switching unit based on the obtained reception sensitivity.

The switching unit may be a single-pole-n-throw (SPnT)-type switch.

The control unit may obtain reception sensitivity of each power receiving coil.

The control unit may compare respective reception sensitivity of the power receiving coils and select a power receiving coil having the best reception sensitivity.

The control unit may obtain reception sensitivity of each power receiving coil at a pre-set interval.

According to another aspect of the present disclosure, an electronic device may include: a power reception unit having a plurality of power receiving coils and receiving a wireless power signal from a wireless power transmission device; a switching unit controlling an ON/OFF switching operation of the plurality of power receiving coils; and a control unit obtaining reception sensitivity of the power reception unit and selecting at least two of the plurality of power receiving coils based on the obtained reception sensitivity.

The control unit may turn on the selected power receiving coils by time division.

The switching unit may be a single-pole-n-throw (SPnT)-type switch.

The control unit may obtain reception sensitivity of each power receiving coil.

The control unit may compare respective reception sensitivity of the power receiving coils and select a power receiving coil based on the comparison results.

According to another aspect of the present disclosure, an electronic device may include: a power reception unit having a plurality of power receiving coils and receiving a wireless power signal from a wireless power transmission device; a switching unit controlling an ON/OFF switching operation of the plurality of power receiving coils; and a control unit selecting at least two of the plurality of power receiving coils by time division.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view conceptually illustrating a wireless power transmission device and an electronic device according to an exemplary embodiment of the present disclosure;

FIGS. 2A and 2B are block diagrams illustrating configurations of a wireless power transmission device and an electronic device employable in exemplary embodiments of the present disclosure;

FIG. 3 is a view illustrating a wireless power transmission system according to an exemplary embodiment of the present disclosure; and

FIGS. 4A through 4C are views illustrating a control method of an electronic device according to another exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like components.

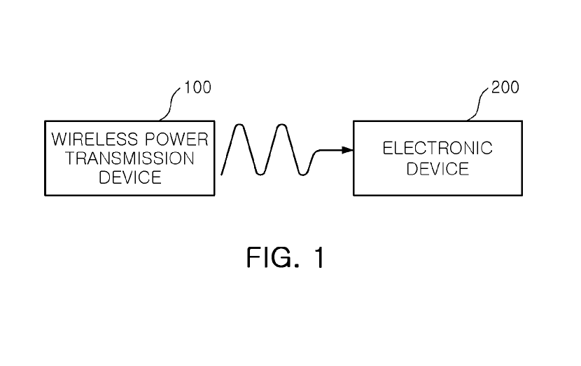

FIG. 1 is a view conceptually illustrating a wireless power transmission device and an electronic device according to an exemplary embodiment of the present disclosure.

With reference to FIG. 1, a wireless power transmission device 100 may be a power transmitting device wirelessly transmitting required power to an electronic device 200.

Also, the wireless power transmission device 100 may be a wireless charging device wirelessly transmitting power to charge a battery disposed within the electronic device 200.

Besides, the wireless power transmission device 100 may be modified as various types of devices transmitting power to the electronic device 200 requiring power in a non-contact manner.

The electronic device 200 is a device operable upon receiving power wirelessly from the wireless power transmission device 100. Also, the electronic device 200 may charge the battery disposed therein with the received wireless power.

Meanwhile, with regard to the electronic device wirelessly receiving power as explained in the present disclosure, the term ‘electronic device’ may be construed as having a meaning comprehensively covering any portable electronic device, for example, a portable phone, a cellular phone, a smartphone, a personal digital assistant (PDA), a portable multimedia player (PMP), a tablet PC, a multimedia device, including an input/output device such as a keyboard, a mouse, an auxiliary video or audio output device, and the like.

Meanwhile, in order to wirelessly transmit power to the electronic device 200 in a non-contact manner, the wireless power transmission device 100 may use one or more wireless power transmission methods. Namely, the wireless power transmission device 100 may transmit power by using at least one scheme of inductive coupling based on electromagnetic induction occurring by a wireless power signal and of magnetic resonance coupling based on electromagnetic resonance occurring by a wireless power signal having a particular frequency.

Wireless power transmission based on the inductive coupling scheme is a technique of wirelessly transmitting power using primary and secondary coils. Namely, a changing magnetic field generated in one coil according to electromagnetic induction induces current to move to the other coil, thus transmitting power.

In the case of wireless power transmission based on resonance coupling scheme, when electromagnetic resonance is generated in the electronic device 200 by a wireless power signal from the wireless power transmission device 100, power is transmitted from the wireless power transmission device 100 to the electronic device due to the resonance phenomenon.

Hereinafter, the wireless power transmission device 100 and the electronic device 200 according to exemplary embodiments of the present disclosure will be described in detail. The same reference numerals will be used to denote the same components although those components are illustrated in different drawings.

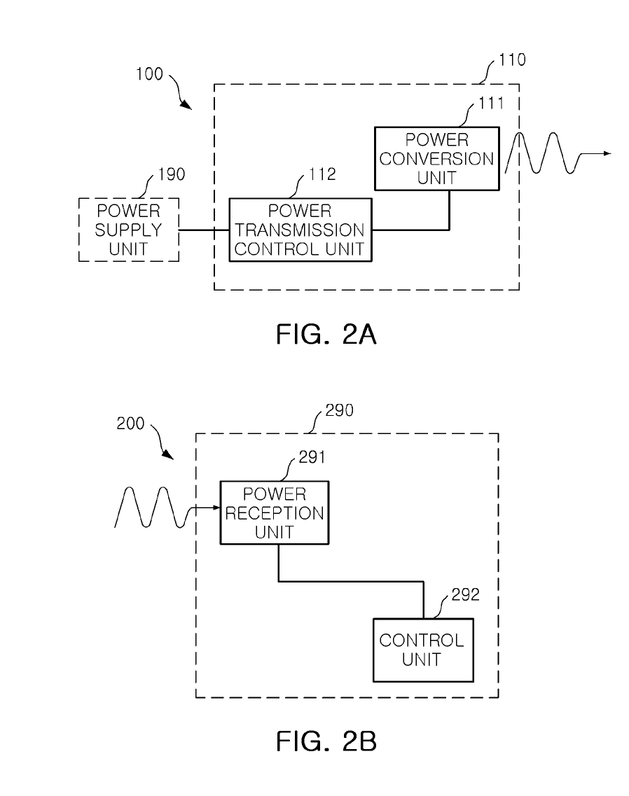

FIGS. 2A and 2B are block diagrams illustrating configurations of the wireless power transmission device 100 and the electronic device 200 employable in exemplary embodiments of the present disclosure.

Referring to FIG. 2A, the wireless power transmission device 100 includes a power transmission unit 110. The power transmission unit 110 may include a power conversion unit 111 and a power transmission control unit 112.

The power conversion unit 111 converts power supplied from a transmission side power supply unit 190 into a wireless power signal and transmits the converted wireless power signal to the electronic device 200. The wireless power signal transmitted by the power conversion unit 111 is a signal in the form of a magnetic field or an electromagnetic field having oscillating characteristics. To this end, the power conversion unit 111 may include a coil generating the wireless power signal.

The power conversion unit 111 may include components for forming various wireless power signals according to respective power transmission schemes.

In some exemplary embodiments, the power conversion unit 111 may be configured to include a primary coil forming a magnetic field changing to induce current to a secondary coil of the electronic device 200 according to inductive coupling. Also, in some exemplary embodiments, the power conversion unit 111 may be configured to include a coil (or an antenna) for forming a magnetic field having a specific resonance frequency to cause a resonance phenomenon in the electronic device 200 according to resonance coupling.

Also, in some exemplary embodiments, the power conversion unit 111 may transmit power by using at least one of the aforementioned inductive coupling and resonance coupling schemes.

Meanwhile, the power conversion unit 111 may further include a circuit for adjusting characteristics of a frequency used, an applied voltage, current, and the like, to form the wireless power signal. The power conversion unit 111 may form the wireless power signal based on a carrier signal modulated in the circuit.

Also, in some exemplary embodiments, the power conversion unit 111 may receive a wireless power signal modulated by the electronic device 200.

The power transmission control unit 112 controls the respective components included in the power transmission unit 110. In some exemplary embodiments, the power transmission control unit 112 may be integrated with a separate controller (not shown) controlling the wireless power transmission device 100.

Meanwhile, there may be two areas that the wireless power signal may reach. First, an active area refers to an area through which the wireless power signal transmitting power to the electronic device 200 passes. Second, a semi-active area refers to an area of interest in which the wireless power transmission device 100 may sense the presence of the electronic device 200. Here, the power transmission control unit 112 may detect whether the electronic device 200 is placed in or removed from the active area or the semi-active area. In detail, the power transmission control unit 112 may detect whether the electronic device 200 is placed in the active area or the semi-active area by using the wireless power signal formed in the power conversion unit 111 or by using a separate sensor. For example, the power transmission control unit 112 may monitor whether the wireless power signal is affected by the electronic device 200 existing in the semi-active area so characteristics of power for forming the wireless power signal are changed in the power conversion unit 111, to thereby detect the presence of the electronic device 200. In this case, the active area and the semi-active area may differ depending on a wireless power transmission scheme such as inductive coupling, resonance coupling, and the like.

The power transmission control unit 112 may perform a process of identifying the electronic device 200 or determine whether to start transmitting wireless power according to the results of detecting the presence of the electronic device 200.

Also, the power transmission control unit 112 may determine at least one of frequency, voltage, and current characteristics of the power conversion unit 111 for forming the wireless power signal. The characteristics may be determined based on conditions of the wireless power transmission device 100 or conditions of the electronic device 200.

Referring to FIG. 2B, the electronic device 200 may include a power supply unit 290. The power supply unit 290 may supply power required for operating the electronic device 200. The power supply unit 290 may include a power reception unit 291 and a control unit (or a micro-controller unit (MCU)) 292.

The power reception unit 291 receives power wirelessly transmitted by the wireless power transmission device 100.

The power reception unit 291 may include a component required for receiving the wireless power signal according to a wireless power transmission scheme. Also, the power reception unit 291 may receive power according to one or more wireless power transmission schemes, and in this case, the power reception unit 291 may include components required for the respective schemes.

First, the power reception unit 291 may be configured to include a coil for receiving a wireless power signal transmitted in the form of a magnetic field or an electromagnetic field having oscillating characteristics.

For example, in some exemplary embodiments, the power reception unit 291 may include a secondary coil inducing current by a changing magnetic field, as a component based on inductive coupling. Also, in some exemplary embodiments, the power reception unit 291 may include a coil and a resonance circuit generating a resonance phenomenon by a magnetic field having a specific resonance frequency, as a component based on resonance coupling.

In some exemplary embodiments, the power reception unit 291 may receive power according to one or more wireless power transmission schemes, and in this case, the power reception unit 291 may be configured to receive power using a single coil or may be configured to receive power using different coils according to respective power transmission schemes.

Meanwhile, the power reception unit 291 may further include a rectifier and a regulator for converting the wireless power signal into direct current (DC). Also, the power reception unit 291 may further include a circuit preventing generation of an overvoltage or an overcurrent by the received power signal.

The control unit 292 controls respective components included in the power supply unit 290.

Hereinafter, a wireless power transmission device and an electronic device applicable to exemplary embodiments of the present disclosure will be described.

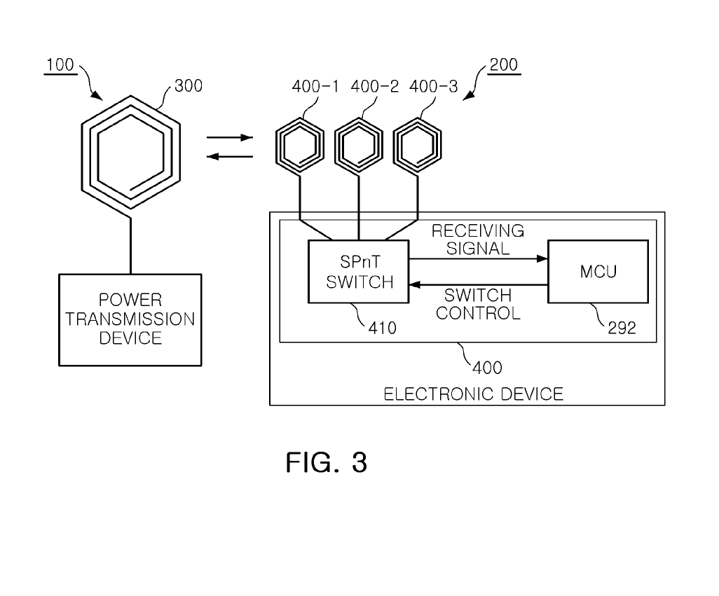

FIG. 3 is a view illustrating a wireless power transmission system according to an exemplary embodiment of the present disclosure.

Referring to FIG. 3, the wireless power transmission system may include the wireless power transmission device 100 and the electronic device 200.

As described above, the wireless power transmission device 100 may include a coil 300 and may transmit a wireless power signal to the electronic device 200.

The electronic device 200 may include a power reception unit 400, a switching unit 410, and a control unit 292.

The power reception unit 400 may receive a wireless power signal from the wireless power transmission device 100. The power reception unit 400 may include a plurality of power receiving coils 400-1, 400-2, and 400-3.

The switching unit 410 may control an ON/OFF switching operation of the plurality of power receiving coils 400-1, 400-2, and 400-3.

In a case in which any one of the power receiving coils 400-1, 400-2, and 400-3 is turned on, the power receiving coil in an ON state may receive a wireless power signal. A power receiving coil in an OFF state may not be used to receive a wireless power signal.

The switching unit 410 may be a single-pole-n-throw (SPnT)-type switch.

The control unit 292 may obtain reception sensitivity of the power reception unit 291. The reception sensitivity may refer to efficiency of the power reception unit 291 receiving a wireless power signal.

In detail, the control unit 292 may obtain reception sensitivity in the plurality of power receiving coils 400-1, 400-2, and 400-3. The control unit 292 may obtain reception sensitivity of each power receiving coil.

For example, the control unit 292 may turn on the first power receiving coil 400-1 and obtain reception sensitivity of the first power receiving coil 400-1. Also, the control unit 292 may turn off the first power receiving coil 400-1 and turn on the second power receiving coil 400-2 to obtain reception sensitivity of the second power receiving coil 400-2. Also, the control unit 292 may turn off the second power receiving coil 400-2 and turn on the third power receiving coil 400-2 to obtain reception sensitivity of the third power receiving coil 400-3.

The control unit 292 may control the switching unit 410 based on the reception sensitivity of the power reception unit 291.

In detail, the control unit 292 may compare respective reception sensitivity values of the power receiving coils and select a power receiving coil having the best reception sensitivity.

Meanwhile, according to the exemplary embodiment of the present disclosure, the control unit 292 may obtain reception sensitivity of each power receiving coil at a pre-set period. Also, the control unit 292 may control the switching unit 410 based on the respective reception sensitivity of the power receiving coils at the pre-set period. For example, the control unit 292 may select the first power receiving coil 400-1 at a first point in time, and select the second power receiving coil 400-2 at a second point in time. The first and second points in time refer to different points in time at which the control unit 292 obtains reception sensitivity of the corresponding power receiving coils.

According to the exemplary embodiment of the present disclosure, the control unit 292 may determine whether reception sensitivity of a wireless power transmission signal has been changed. When the control unit 292 detects that reception sensitivity of the wireless power transmission signal has been changed, the control unit 292 may compare respective reception sensitivity values of the power receiving coils, and select a power receiving coil having the best reception sensitivity.

In order to increase a charging distance between the wireless power transmission device and the wireless power reception device, a size of a coil and the number of circuits in the wireless power transmission device are increased, resulting in an increase in a size of a system and costs thereof.

In contrast, in the case of the wireless power transmission system according to the exemplary embodiment of the present disclosure, a degree of freedom in charging of the system may be enhanced with a relatively small size and at relatively low cost.

Also, in a general wireless charging system, differences arise in sensitivity of receiving signals according to positions of coils, making differences in charging efficiency. In contrast, the electronic device according to the exemplary embodiment of the present disclosure may compare reception sensitivity values in every pre-set period or whenever required and receive the most efficient wireless power transmission signal. Thus, the electronic device according to the exemplary embodiment of the present disclosure may have enhanced charging efficiency.

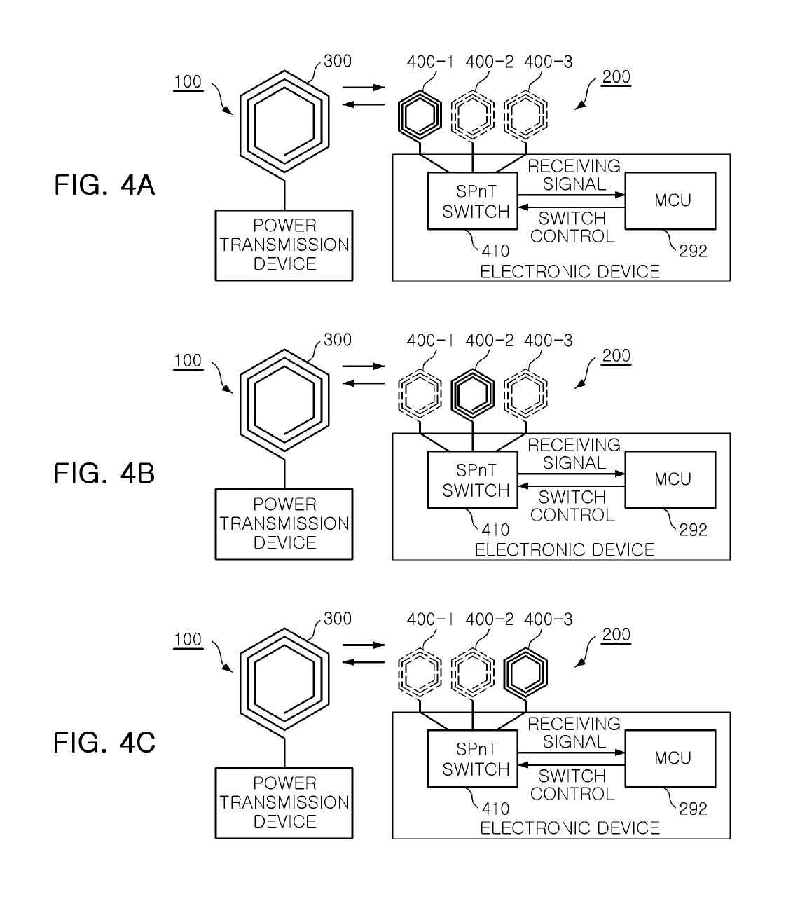

FIGS. 4A through 4C are views illustrating a control method of an electronic device according to another exemplary embodiment of the present disclosure.

According to the exemplary embodiment, the control unit 292 may select at least two of the plurality of power receiving coils by time division.

In the exemplary embodiment of the present disclosure, a case in which the control unit 292 selects three power receiving coils 400-1, 400-2, and 400-3 by time division will be described by way of example.

In a first section, the control unit 292 may turn on the first power receiving coil 400-1 and the electronic device 200 may receive a wireless power transmission signal through the first power receiving coil 400-1 (see FIG. 4A).

In a second section, the control unit 292 may turn on the second power receiving coil 400-2 and the electronic device 200 may receive a wireless power transmission signal through the second power receiving coil 400-2 (see FIG. 4B).

In a third section, the control unit 292 may turn on the third power receiving coil 400-3 and the electronic device 200 may receive a wireless power transmission signal through the third power receiving coil 400-3 (see FIG. 4C).

A single period may be divided into the first to third sections, and the electronic device 200 may receive a wireless power transmission signal through repetition of the period as described above.

According to the present exemplary embodiment, the electronic device 200 may continuously receive a wireless power transmission signal, without obtaining reception sensitivity of each of the power receiving coils.

In an environment in which relative positions between the electronic device 200 and the wireless power transmission device 100 are continuously changed, the aforementioned method may increase wireless power transmission efficiency.

Also, according to another exemplary embodiment, the control unit 292 may obtain reception sensitivity of the power reception unit 291 and select at least two of the plurality of power receiving coils based on the obtained reception sensitivity. In this case, the control unit 292 may turn on the selected coils by time division.

According to the aforementioned method, in an environment in which relative positions between the electronic device 200 and the wireless power transmission device 100 are continuously changed, efficiency of the electronic device 200 receiving wireless power may be maximized.

The methods according to the exemplary embodiments of the present disclosure may be used alone or in a combined manner. Also, operations of an exemplary embodiment may be individually used, or may be combined with operations of another exemplary embodiment.

The above-described methods may be implemented in a recording medium that may be read by a computer or a similar device by using software, hardware, or a combination thereof.

For hardware implementation, the above-described methods may be implemented by at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing any other functions.

For software implementation, the procedures and functions described in the present disclosure may be implemented in the form of software modules. The software modules may be implemented by software codes written in appropriate program languages. The software codes may be stored in a storage unit and executed by a processor.

As set forth above, according to exemplary embodiments of the present disclosure, an electronic device capable of enhancing wireless charging efficiency may be provided.

In addition, an electronic device capable of enhancing a degree of freedom of charging may be provided.

While exemplary embodiments have been shown and described above, it will be apparent to those skilled in the art that modifications and variations could be made without departing from the spirit and scope of the present disclosure as defined by the appended claims.

What is claimed is:

1. An electronic device comprising:
a power reception unit having a plurality of power receiving coils and receiving a wireless power signal from a wireless power transmission device;
a switching unit controlling an ON/OFF switching operation of the plurality of power receiving coils; and
a control unit obtaining reception sensitivity of the power reception unit and controlling the switching unit based on the obtained reception sensitivity.

2. The electronic device of claim 1, wherein the switching unit is a single-pole-n-throw (SPnT)-type switch.

3. The electronic device of claim 1, wherein the control unit obtains reception sensitivity of each power receiving coil.

4. The electronic device of claim 3, wherein the control unit compares respective reception sensitivity of the power receiving coils and selects a power receiving coil having the best reception sensitivity.

5. The electronic device of claim 4, wherein the control unit obtains reception sensitivity of each power receiving coil at a pre-set period.

6. An electronic device comprising:
a power reception unit having a plurality of power receiving coils and receiving a wireless power signal from a wireless power transmission device;
a switching unit controlling an ON/OFF switching operation of the plurality of power receiving coils; and
a control unit obtaining reception sensitivity of the power reception unit and selecting at least two of the plurality of power receiving coils based on the obtained reception sensitivity.

7. The electronic device of claim 6, wherein the control unit turns on the selected power receiving coils by time division.

8. The electronic device of claim 6, wherein the switching unit is a single-pole-n-throw (SPnT)-type switch.

9. The electronic device of claim 6, wherein the control unit obtains reception sensitivity of each power receiving coil.

10. The electronic device of claim 9, wherein the control unit compares respective reception sensitivity of the power receiving coils and selects a power receiving coil based on the comparison results.

11. An electronic device comprising:
a power reception unit having a plurality of power receiving coils and receiving a wireless power signal from a wireless power transmission device;
a switching unit controlling an ON/OFF switching operation of the plurality of power receiving coils; and
a control unit selecting at least two of the plurality of power receiving coils by time division.
